(19) United States
(12) Patent Application Publication
(10) Pub. No.: US 2016/0265475 A1
(43) Pub. Date: Sep. 15, 2016

(54) Cylinder Head/Cylinder Block Joint

(71) Applicant: Caterpillar Inc., Peoria, IL (US)

(72) Inventors: Richard Havran, Salem, SC (US); Marius Nan, West Lafayette, IN (US); Fred Ananias, Dunlap, IL (US)

(73) Assignee: Caterpillar Inc., Peoria, IL (US)

(21) Appl. No.: 14/645,068

(22) Filed: Mar. 11, 2015

(51) Int. Cl. F02F 11/00; F02F 7/00; F02F 1/24; F02F 1/00; F02F 1/14

(52) U.S. Cl. CPC F02F 11/002; F02F 1/004; F02F 1/14; F02F 1/24; F02F 7/0095

(57) ABSTRACT

The document discloses an internal combustion engine having an improved cylinder head/block joint or cylinder head/cylinder block connection. The top deck of the cylinder block includes smaller coolant passages and longer axial bosses. The longer axial bosses permit the use of longer head bolts and longer threaded holes in the cylinder block for accommodating the longer head bolts for a robust cylinder head/cylinder block joint.

### BACKGROUND

1. Technical Field

This disclosure relates to a connection between a cylinder head and a cylinder block of an internal combustion engine. More specifically, this disclosure relates to improvements in the design of cylinder blocks and head bolts that connect the cylinder head to the cylinder block to form an improved cylinder head/block joint.

2. Description of the Related Art

Internal combustion engines provide power to a vast array of machines and vehicles. In order to remove excess heat and to keep an engine operating at the most efficient temperature, the engine is equipped with a cooling system and a lubricant system to provide coolant and lubricant to various parts or areas of the engine. Specifically, the cylinder block and the cylinder head include an array of coolant passages for delivering coolant to various parts of the engine. Similarly, the cylinder block and the cylinder head include an array of lubricant passages for delivering lubricant to various parts of the engine.

The cylinder head/block joint is a critical sealing joint in an internal combustion engine, Gaskets at the cylinder head/block joint can safeguard against leakage of fluids, and more specifically, can prevent coolant, lubricant and the like from contaminating each other. Further, a fire ring sandwiched between a flanged portion of the cylinder liner and the cylinder head may be employed to seal combustion gases as disclosed in U.S. Pat. No. 5,603,515. Gaskets, fire rings and the cylinder head/block joint also maintain a proper operating pressure within the combustion chambers or cylinder bores. However, even with the use of gaskets and fire rings, the cylinder head/cylinder block joint may not provide adequate sealing.

This document discloses improvements to cylinder blocks and head bolts for overcoming inadequate sealing at the cylinder head/cylinder block joint.

### SUMMARY OF THE DISCLOSURE

In one aspect, this document discloses an internal combustion engine. The engine may include a cylinder head and a cylinder block. The cylinder head may include an array of through holes. The cylinder block may include a cylinder bore and an array of threaded holes that surround the cylinder bore and that are in matching registry with the array of through holes of the cylinder head. The cylinder bore may be defined by an inner wall surface. The inner wall surface may include a plurality of circumferentially aligned and spaced-apart cooling passages and a plurality of uninterrupted inner wall portions. Each uninterrupted inner wall portion extends circumferentially between two coolant passages. Each coolant passage may have a circumferential width. Each uninterrupted inner wall portion may have a circumferential length that is greater than the circumferential width of each coolant passage.

In another aspect, this document discloses a cylinder block for an internal combustion engine. The cylinder block may include a cylinder bore and an array of threaded holes that surround the cylinder bore. The cylinder bore may be defined by an inner wall surface. The inner wall surface may include a plurality of circumferentially aligned and spaced-apart coolant passages and a plurality of uninterrupted inner wall portions. Each uninterrupted inner wall portion may extend circumferentially between two coolant passages. Each coolant passage may have a circumferential width. Each uninterrupted inner wall portion may have a circumferential length that is greater the circumferential width of each coolant passage.

In yet another aspect, this document discloses a method for improving a seal provided by a cylinder head joint. The method may include providing a cylinder head including an array of through holes. The method may further include providing a cylinder block including a cylinder bore and an array of threaded holes that surround the cylinder bore and that are in matching registry with the array of through holes in the cylinder head. The cylinder bore may be defined by an inner wall surface. The inner wall surface may include a plurality of circumferentially aligned and space-apart coolant passages and a plurality of uninterrupted inner wall portions. Each uninterrupted inner wall portion may extend circumferentially between two coolant passages. Each coolant passage may have a circumferential width. Each uninterrupted wall portion may have a circumferential length that is at least about twice the circumferential width of each coolant passage. The inner wall surface may further include a plurality of axial bosses. Each axial boss may be in alignment with one of the threaded holes and each threaded hole may extend at least partially and axially along one of the axial bosses. The cylinder bore is lined with a cylinder liner. The cylinder liner includes a flanged portion sandwiched between the cylinder block and the cylinder head and a cylindrical portion extending from the flange to a distal end within the cylinder bore. The cylindrical portion of the cylinder liner has an axial length. The method may further include connecting the cylinder head to the cylinder block with a plurality of head bolts with each head bolt passing through one of the through holes and extending into one of the threaded holes and at least partially and axially along one of the axial bosses so that each head bolt threadably extends into one of the threaded holes for an axial length that is at least about 25% of the axial length of the cylindrical portion of the cylinder liner.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a partial sectional view of an internal combustion engine taken substantially along line 1-1 of FIG. 3, and particularly illustrating a disclosed cylinder head/block joint, cylinder liner and a spacer plate.

FIG. 2 is another partial sectional view of the internal combustion engine shown in

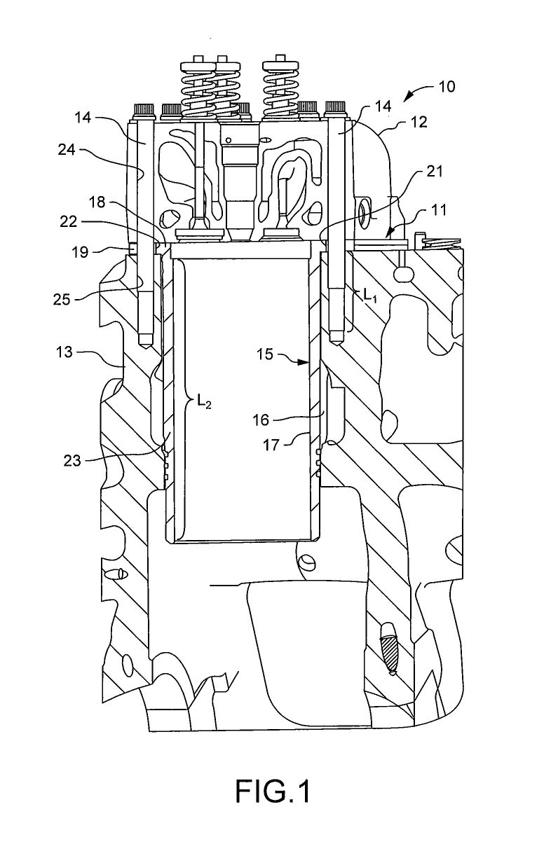

FIG. 1 with the cylinder liner removed thereby exposing the coolant passages.

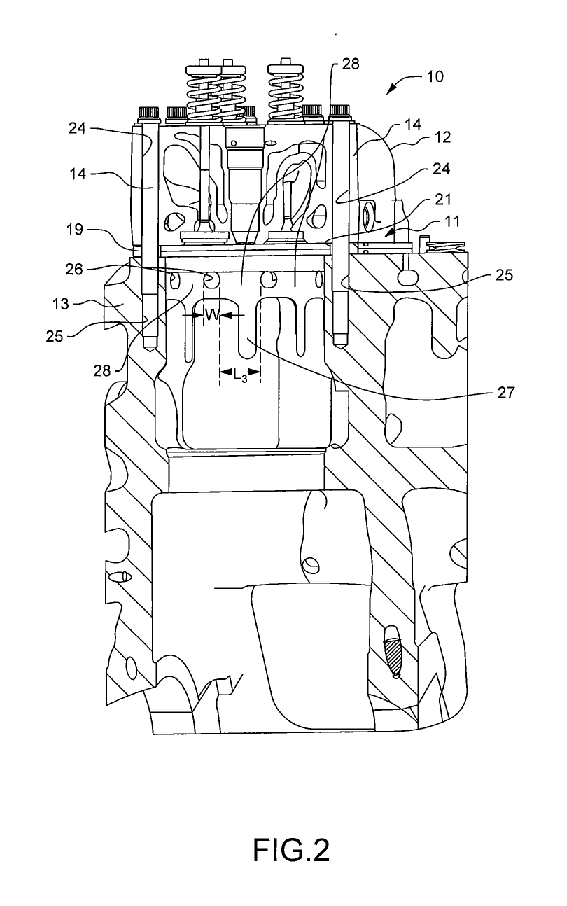

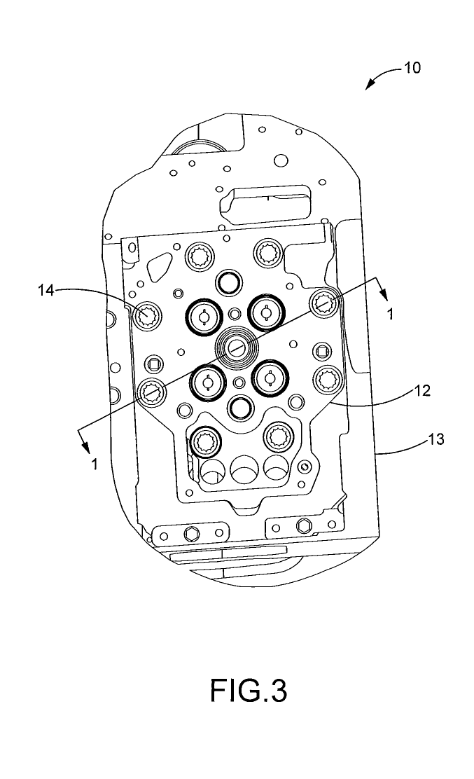

FIG. 3 is a partial top plan view of the cylinder head and cylinder block illustrated in FIGS. 1-2.

The drawings are not necessarily to scale and may illustrate the disclosed embodiments diagrammatically and in partial views. In certain instances, the drawings may omit details which are not necessary for an understanding of the disclosed methods and apparatuses or which render other details difficult to perceive. This disclosure is not limited to the particular embodiments illustrated herein.

### DETAILED DESCRIPTION OF THE DRAWINGS

Referring to FIGS. 1-2, an internal combustion engine 10 includes a cylinder head/block joint 11 formed by a cylinder head 12 mounted and clamped onto a cylinder block 13 using a plurality of head bolts 14. FIG. 3 shows a cylinder liner 15 disposed within a bore 16 that is disposed in a cylinder block 13. The cylinder liner 15 defines a cylinder bore 17 and may include a flanged portion 18 that extends into the cylinder head/block joint 11 and a cylindrical portion 23 that extends axially into the bore 16 in the cylinder block 13. A spacer plate 19 may be mounted between the cylinder head 12 and the cylinder block 13 and may include an opening 21 that receives the flanged portion 18 of the cylinder liner 15. The spacer plate 19 distributes both mechanically and thermally induced loads from the cylinder head 12 to the cylinder block 13 without concentrating loads at any one portion of the cylinder block 13. An integral head gasket may be clamped between the cylinder head 12 and the cylinder liner 15 for sealing combustion gases and a fire ring 22 may be provided and clamped between the flanged portion 18 of the cylinder liner 15 and the cylinder head 12.

A plurality of head bolts 14 may couple the cylinder head 12 to the cylinder block 13. The disclosed engine 10 employs eight (8) head bolts 14 for this purpose as shown in FIG. 3. The head bolts 14 extend through holes 24 that pass through the cylinder head 12. The array of holes 24 (see FIGS. 1-2) in the cylinder head 12 are in matching registry with an array of threaded holes 25 disposed in the cylinder block 13. Like the threaded holes 25, the holes 24 may also include internal threads. To accommodate longer head bolts 14, the threaded holes 25 and the head bolts 14 have been lengthened. Specifically, the threaded portion of each threaded hole 25 that threadably receives a lower portion of a head bolt 14 has an axial length L₁ as shown in FIG. 1 that is at least about 25% of the axial length L₂ of the cylindrical portion 23 of the cylinder liner 15. In other words, the length L₁ of threaded engagement between each head bolt 14 and each threaded hole 25 of the cylinder block 13 is at least about 25% of the axial length L₂ of the cylindrical portion 23 of the cylinder liner 15. Use of the longer head bolts 14 provides improved resistance to clamp load loss.

The longer head bolts 14 and longer threaded holes 25 are in axial alignment with elongated axial bosses 27 as shown in FIG. 1. The axial bosses 27 have been lengthened to enable the cylinder block 13 to accommodate the longer head bolts 14 and longer threaded holes 25. The longer head bolts 14 and longer threaded holes 25 further contribute to the more robust cylinder head/block joint 11.

Turning to FIG. 2, to increase the stiffness of the upper portion of the cylinder block 13, the cylinder block 13 includes coolant passages 26 that are reduced in size to match flow requirements. The coolant passages 26 may have a circumferential width W and each coolant passage 26 may be separated from an adjacent coolant passage 26 by an uninterrupted inner wall portion 28. The uninterrupted inner wall portions 28 may be of a circumferential length L₃ that is greater than the circumferential width W of each coolant passage 26. In one embodiment, the circumferential length L₃ may be at least about twice the circumferential width W. In yet another embodiment, the circumferential length L₃ may be greater than twice the circumferential width W. Thus, instead of occupying a majority of the space or volume of the top deck or upper portion of the cylinder block 13, the coolant passages 26 are relatively small, and are spaced apart by uninterrupted inner wall portions 28 that are longer than the coolant passages 26 are wide. The structure shown in FIG. 2 adds to the overall integrity of the top deck or upper portion of the cylinder block 13 and enables the cylinder block 13 to withstand the more uniform distribution of clamping forces exerted on it.

### INDUSTRIAL APPLICABLITY

An internal combustion engine 10 includes a more robust cylinder head/block joint 11 or cylinder head 12/cylinder block 13 connection. The cylinder head 12 may include an array of holes 24 arranged around a bore 16 in the cylinder block 13. Similarly, the cylinder block 13 may include an array of threaded holes 25 that are in matching registry with the holes 24 of the cylinder head 12. The threaded holes 25 may be longer or deeper than earlier designs so they can accommodate longer head bolts 14 for a more robust cylinder head/block joint 11. An axial length L₁ of the threaded engagement between each head bolt 14 and each threaded hole 25 may be at least about 25% of the axial length L₂ of cylindrical portion 23 of the cylinder liner 15. The cylinder block 13 can accommodate longer threaded holes 25 and longer head bolts 14 at least in part because the axial bosses 27 that extend axially between two coolant passages 26 have been lengthened. The coolant passages 26 and axial bosses 27 are disposed circumferentially around a bore 16 in the cylinder block 13 at the top deck or upper portion of the cylinder block 13. Each axial boss 27 is disposed between two coolant passages 26 and vice versa. Further, each axial boss 27 is disposed in axial alignment with one of the threaded holes 25 and the threaded holes 25 may be longer or deeper and may accommodate longer head bolts 14 for a more robust cylinder head/block joint 11. Uninterrupted inner wall portions 28 disposed between the coolant passages 26 have a circumferential length L₃ that is longer or wider than the circumferential width W of the coolant passages 26, thereby strengthening the upper portion or top deck of the cylinder block 13. The stronger top deck of the cylinder block 13 also provides for a more robust cylinder head/block joint 11.

While only certain embodiments have been set forth, alternatives and modifications will be apparent from the above description to those skilled in the art. These and other alternatives are considered equivalents and within the spirit and scope of this disclosure and the appended claims.

What is claimed:

1. An engine comprising:
a cylinder head and a cylinder block,
the cylinder bore defined by an inner wall surface, the inner wall surface including a plurality of circumferentially aligned and spaced-apart coolant passages and a plurality of uninterrupted inner wall portions, each uninterrupted inner wall portion extending circumferentially between two coolant passages, each coolant passage having a circumferential width, each uninterrupted inner wall portion having a circumferential length that is greater the circumferential width of each coolant passage.

2. The engine of claim 1 wherein the circumferential length of each uninterrupted inner wall portion is about twice the circumferential width of each coolant passage.

3. The engine of claim 1 wherein the circumferential length of each uninterrupted inner wall portion is greater than twice the circumferential width of each coolant passage.

4. The engine of claim 1 wherein the cylinder head includes an array of through holes,
the cylinder block includes a cylinder bore and an array of threaded holes that surround the cylinder bore and that are in matching registry with the array of through holes of the cylinder head, the cylinder bore accommodating a cylindrical portion of a cylinder liner, the cylindrical portion having an axial length,
a plurality of head bolts, each head bolt passing through one of the through holes in the cylinder head and threadably engaging one of the threaded holes in the cylinder block, each head bolt extending into and threadably engaging its respective threaded hole for an axial length that is at least about 25% of the axial length of the cylindrical portion of the cylinder liner.

5. The engine of claim 4 wherein each head bolt extends into and threadably engages its respective threaded hole for an axial length that greater than 25% of the axial length of the cylindrical portion of the cylinder liner.

6. The engine of claim 1 wherein the threaded holes in the cylinder block include more than 60 threads.

7. The engine of claim 1 wherein the threaded holes include about 100 threads.

8. The engine of claim 1 wherein the plurality of through holes includes eight through holes, the plurality of threaded holes includes eight threaded holes and the plurality of coolant passages includes eight coolant passages.

9. The engine of claim 1 wherein each threaded hole extends axially between two coolant passages.

10. The engine of claim 1 wherein the inner wall surface includes a plurality of axial bosses, each axial boss in axial alignment with one of the threaded holes.

11. A cylinder block for an internal combustion engine, the cylinder block comprising:
a cylinder bore and an array of threaded holes that surround the cylinder bore,
the cylinder bore defined by an inner wall surface, the inner wall surface including a plurality of circumferentially aligned and spaced-apart coolant passages and a plurality of uninterrupted inner wall portions, each uninterrupted inner wall portion extending circumferentially between two coolant passages, each coolant passage having a circumferential width, each uninterrupted inner wall portion having a circumferential length that is at least about twice than the circumferential width of each coolant passage.

12. The cylinder block of claim 11 wherein the circumferential length of each uninterrupted inner wall portion is greater than twice the circumferential width of each coolant passage.

13. The cylinder block of claim 11 wherein the cylinder block includes a cylinder bore and an array of threaded holes that surround the cylinder bore, the cylinder bore accommodating a cylindrical portion of a cylinder liner, the cylindrical portion having an axial length,
each threaded hole having a threaded axial length that is at least about 25% of the axial length of the cylindrical portion of the cylinder liner.

14. The cylinder block of claim 13 wherein the axial length of each threaded hole is greater than 25% of the axial length of the cylindrical portion of the cylinder liner.

15. The cylinder block of claim 11 wherein the threaded holes include more than 60 threads.

16. The cylinder block of claim 11 wherein the threaded holes include about 100 threads.

17. The cylinder block of claim 11 wherein the plurality of threaded holes includes eight threaded holes and the plurality of coolant passages includes eight coolant passages.

18. The cylinder block of claim 11 wherein each threaded hole extends axially between two coolant passages.

19. The cylinder block of claim 11 wherein the inner wall surface includes a plurality of axial bosses, each axial boss in axial alignment with one of the threaded holes, each threaded hole passing at least partially and axially along one of the axial bosses.

20. A method for improving a seal provided by cylinder head joint, the method comprising:
providing a cylinder head including an array of through holes;
providing block including a cylinder bore and an array of threaded holes that surround the cylinder bore and that are in matching registry with the array of through holes of the cylinder head, the cylinder bore defined by an inner wall surface, the inner wall surface including a plurality of circumferentially aligned and spaced-apart coolant passages and a plurality of uninterrupted inner wall portions, each uninterrupted inner wall portion extending circumferentially between two coolant passages, each coolant passage having a circumferential width, each uninterrupted inner wall portion having a circumferential length that is about twice the circumferential width of each coolant passage, the inner wall surface further including a plurality of axial bosses, each axial boss in alignment with one of the threaded holes and each threaded hole extending at least partially and axially along one of the axial bosses, the cylinder bore lined with a cylinder liner, the cylinder liner including a flanged portion sandwiched between the cylinder block and the cylinder head and a cylindrical portion extending from the flange to a distal end within the cylinder bore, the cylindrical portion of the cylinder liner having an axial length;
connecting the cylinder head to the cylinder block with a plurality of head bolts with each head bolt passing through one of the through holes and extending into one of the threaded holes and at least partially and axially along one of the axial bosses so that each head bolt threadably extends into one of the threaded holes for an axial length that is at least about 25% of the axial length of the cylindrical portion of the cylinder liner.
